(19) United States
(12) Patent Application Publication
(10) Pub. No.: US 2008/0184587 A1
(43) Pub. Date: Aug. 7, 2008

(54) High efficiency drier with multi stage heating and drying zones

(76) Inventor: Steve D. Shivvers, Prole, IA (US)

Correspondence Address: John C. McMahon, P.O.Box 30069, Kansas City, MO, 64112, US

(21) Appl. No.: 12/012,551

(22) Filed: Feb. 4, 2008

Related U.S. Application Data
(60) Provisional application No. 60/899,227, filed on Feb. 2, 2007.

(51) Int. Cl. F26B 3/04

(52) U.S. Cl. 34/491; 34/135

(57) ABSTRACT

A drier for drying wet material includes a drying chamber with a plurality of heating region regions and a plurality of drying regions, alternatively located along the path of the material through the drier. Each of the heating regions is heated with heating fluid by a heating recirculation system wherein the heating fluid overall flows generally concurrently with the material in the chamber, but wherein the heating fluid can flow in various ways within each heating region. A fluid circulation system flows drying fluid through each of the drying regions generally in countercurrent flow relative to the flow of material through the drier, although the drying fluid can flow in various ways within each drying region. The drying fluid exiting the drier is used to preheat the heating fluid exiting the drier prior to the heating fluid reentering the drier. Makeup heat is supplied to the system.

### CROSS REFERENCE TO RELATED APPLICATIONS

This application claims the benefit of U.S. Provisional Application No. 60/899,227, filed Feb. 2, 2007 which is incorporated herein by reference.

### STATEMENT REGARDING UNITED STATES GOVERNMENT SPONSORED RESEARCH OR DEVELOPMENT

The present invention was at least in part made with support from the United States Government under Contract No. 2005-33610-15517 awarded by the USDA SBIR. The United States Government has certain rights in the invention.

### BACKGROUND OF THE INVENTION

The present invention is directed to improvements in driers and methods of drying used to dry various materials, including newly harvested grain, wood pellets, and particulate materials of all types and, in particular, to driers that utilize fluid to heat the material, cool and dry the material with generally overall countercurrent air flow and recover and utilize a comparatively high percentage of the energy used in the drying process.

The drying industry is very large and utilizes significant amounts of both fossil fuels and electricity to dry various materials. While the grain industry is not the only industry that requires significant drying, it is indicative of the problems that exist. Just the United States corn crop amounts to over nine billion bushels annually. At least part of the moisture present at harvest must be removed in order to allow the grain to be stored without significant loss due to mold, mildew and rot, all caused by excess retained moisture.

In theory, each pound of water removed from the grain has a latent heat of vaporization of about 1160 British thermal units (Btu) per pound. In an extremely effective drier system, the drier could import exactly this theoretical amount of energy per pound of water to be removed from the material to be dried. In reality, the material to be dried also takes on sensible heat and rises in temperature, the flow of heating media is often not uniform, the material is often heated more on one side of the drier than the other, etc., such that the efficiency of all types of conventional driers is comparatively low. For example, conventional cross flow grain driers usually require approximately more than 2000 Btu per pound of water removed versus the theoretical amount of 1160 Btu per pound.

Because just the corn industry in the United States consumes approximately 900 million gallons of propane and over 3200 million kilowatt-hours of electricity per year just to dry the corn and because this produces nearly two million tons of carbon dioxide exhaust gases per year because of the burning of fossil fuels, it is seen that any improvement in drying efficiency can amount to significant savings in fuel, energy and emissions. Corn is only one type of grain that must be dried. Further, there are many other solids, semi-solids and initially liquid compositions that are dried each year at considerable costs in terms of fuel, energy and undesired emissions due to combustion of the fuels.

It is further noted that for some materials the manner of drying is important to prevent excessive shock to the product being dried and/or to reduce inconsistency in the dried material. For example, grain kernels can be cracked by cooling or heating too quickly, which can lead to degradation of the grain. While conventional driers may produce a chosen average moisture content, the content may not be consistent throughout the grain. Consequently, problems are encountered generally in many types of conventional grain cross flow driers, where the grain is heated and dried by air passing perpendicularly to the flow of the grain. In such driers, the grain on one side of the drier that first encounters the heated air is overly dried and may be dried too quickly or cooled too quickly so as to cause cracking and the grain on the opposite or on the air discharge side tends to be too wet.

In some circumstances, it is also desirable to provide a closed recycle system for gas used in the drying process to reduce dust or other undesirable emissions.

### SUMMARY OF THE INVENTION

A high efficiency drier for drying materials, especially particulate material of all types, that recovers and reutilizes heat used in the drying process, such that only a comparatively small amount of makeup heat must be added to the process.

The drier includes a generally enclosed drying chamber, a heating fluid recirculation system, a drying fluid circulation system, a regenerator, and a makeup heater.

The drying chamber has at least one heating region and may have a plurality of heating regions or compartments and at least one drying region and may have a plurality of drying regions or compartments which alternate along the path of material being dried, such that the material passes first through a heating compartment wherein heat energy is provided to the material to vaporize moisture and subsequently passes through a paired drying compartment wherein an unsaturated drying fluid is passed in close association with the material where the drying fluid can absorb moisture from the material, so as to take up and remove the vaporized moisture. It is noted that adiabatic phase change of moisture from a liquid to a vapor is accompanied by a decrease in temperature (evaporative cooling or wet bulb effect) such that the temperature of the material decreases from its highest value, preferably within the confines of the first heating compartment, to a lowest value at the material discharge end of the drying chamber. It is further noted that the unsaturated state of the drying fluid may be the result of being heated by the material and that the drying fluid could be saturated or almost fully saturated when initially entering the drying chamber in some embodiments. This process is preferably repeated at least two times with passes through heating and subsequent drying compartments.

The heating compartments are heated by a heating fluid circulated through each heating compartment by the heating fluid recirculation system. The material has a general path that the material follows through the drier. The heating fluid generally flows concurrently with the material with respect to the drier as a whole. In particular, the heating fluid flows through subsequent heating compartments in the same order that the material to be dried flows through the heating compartments. However, the flow of heating fluid through each individual heating compartment can vary and may be concurrent, cross current, countercurrent, or other mixed flows with respect to the movement of the material to be dried within each heating compartment. In a particular embodiment wherein a single heating region is coupled with a single drying region, the heating fluid may flow counter current to the material.

The heating fluid enters the drying chamber in a hot state and the recirculation system circulates the heating fluid sequentially through each heating compartment along the path of the material to be dried. The heating fluid exits the drying chamber in a comparatively cool state and is conveyed by the heating fluid recirculation system to the regenerator. The heating fluid is preheated in the regenerator by heat exchange with the drying fluid. The regenerator is preferably a shell and tube heat exchanger, but may be another type of heat exchanger. The heating fluid can be gaseous (such as air, nitrogen or the like) or liquid (such as oil); however, the heating fluid is often preferably water.

The makeup heater provides heat to the heating fluid to raise the temperature thereof to a preselected range or specific temperature prior to entering the drying chamber. Preferably, the heating fluid recirculation system returns the heating fluid from the regenerator to the drying chamber through the makeup heater; however, heat can be added at other locations such as directly to the material prior to entering the drying chamber.

The drying fluid circulation system circulates a drying fluid sequentially through the drying compartments in reverse order to the flow of material through the drying compartments. Preferably, the drying fluid is air and further preferably the drying fluid is ambient air, although other fluids such as nitrogen may be used, if necessitated by the processing needs. The drying fluid must be able to absorb, carry, or take up moisture released by the material. With air as the drying fluid, the air becomes heated as it passes though the material previously heated in the heating compartments and becomes saturated or at least partially saturated with moisture. The heating fluid generally bypasses the drying compartments and the drying fluid preferably at least in part bypasses or substantially bypasses the heating compartments.

The drying fluid enters the drying chamber in a cool preferably dry state and exits the drying chamber in a warm wet state. The terms dry and wet are not intended to indicate relative humidity or saturation at a particular temperature, but rater the total moisture content of the drying fluid entering and exiting the drying chamber. That is, the drying fluid contains more total moisture when exiting the drying chamber than when entering the drying chamber. Upon exiting the drying chamber, the drying fluid is transported by the drying fluid circulation system to the regenerator wherein the drying fluid in a warm state transfers heat to the heating fluid that enters the regenerator in a comparatively cool state. Condensation that collects due to the cooling of the drying fluid in the regenerator is collected and discharged.

The drying fluid is most often discharged from the regenerator into the air. However, in some instances the drying fluid may carry too much pollution, such as dust, or may be too expensive to waste and, in such situations, the drying fluid exiting the regenerator may be returned to the drying chamber. In such circumstances a chiller with a condensate drain may be required to chill the drying fluid returning to the drying chamber a small amount to assure that the temperature of the drying fluid is decreased to or maintained at a preselected temperature, such as 70° F., prior to reintroduction to the drying chamber. If the temperature of the recycled drying fluid is not reduced between the regenerator and the drying chamber, the drying potential of the chamber may be markedly decreased. Chilling may be through a refrigeration unit, a heat pump or the like. A heat pump, when used for this purpose, has the advantage of recapturing the energy removed from the recycled drying fluid for reintroduction of the heat to the heating fluid in the region between the regenerator and the makeup heater or to the material to be dried in a preheater prior to the first heating compartment or elsewhere in the drier.

The drying fluid flows generally overall counter currently to the flow of material in the drier. However, the drying fluid can be in countercurrent, concurrent, cross, mixed or other flow relative to the material in each individual drying regions or compartment.

The drying chamber can be many different structures modified to have a plurality of heating and drying compartments including vertical column, rotating drum, fluidized bed, round plate, conveyor, rotating disc; rotating screw, rotating plough, paddle, tray, belt, tunnel, web, band, and the like. In accordance with the invention, the heating and drying compartments are not required to have fixed structure defining the compartments, but may be regions within which the heating and drying functions occur.

The drier and drying process of the invention are especially advantageous in consistently and uniformly removing moisture with low stress from a material with a minimal input of heat. Further, the drier and process provide the advantage of being adaptable to a closed system to reduce undesirable emissions to the air.

### OBJECTS AND ADVANTAGES OF THE INVENTION

Therefore, the objects of the invention are: to provide a drier that is highly efficient with respect to use of energy; to provide such a drier wherein heat is recovered and reused; to provide such a drier having a plurality of heating compartments and drying compartments alternatively located along the path of flow that the material to be dried traverses through the drier; to provide such a drier wherein heating fluid is flowed generally overall concurrently with respect to the material while drying fluid is flowed generally overall countercurrently with respect to the material through the drier; to provide such a drier wherein heating fluid and drying fluid is flowed concurrently, countercurrently, cross, mixed or otherwise through individual heating compartments and drying compartments; to provide such a drier where, when only one heating region is coupled with only one drying region, the heating fluid may flow countercurrent to the flow of the material; to provide such a drier wherein drying fluid exiting the drier is utilized to preheat heating fluid entering the drier; to provide such a drier where a heat pump may be utilized to further extract heat from the drying fluid that is exhausted from the drier and thereafter use the extracted heat to preheat the material, to add head to the drier elsewhere, or the like; to provide such a drier that is comparatively inexpensive to operate, easy to use and especially well adapted for the intended usage thereof and to provide a process for effectively utilizing such a drier.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a partially schematic side elevational view of a drier in accordance with the present invention.

FIG. 1A is a partially schematic side elevational view of a first modified drier in accordance with the present invention.

FIG. 1B is a partially schematic side elevational view of a second modified drier in accordance with the present invention.

FIG. 1C is a partially schematic side elevational view of a third drier in accordance with the present invention.

FIG. 2 is a perspective view of a fourth drier in accordance with the present invention with a top of a drying chamber thereof mostly broken away to better illustrate the interior structure thereof.

FIG. 3 is a partially schematic and top plan view of the drier of FIG. 2 with the top of the drying chamber mostly broken away to show interior detail thereof.

FIG. 4 is a partially schematic side elevational view of a fifth drier in accordance with the present invention.

FIG. 5 is a partially schematic and cross sectional view of the side elevation of a sixth drier in accordance with the present invention having a drying chamber.

FIG. 6 is a perspective view of the drying chamber of the drier of FIG. 5 with a front half broken away to better illustrate the interior thereof.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

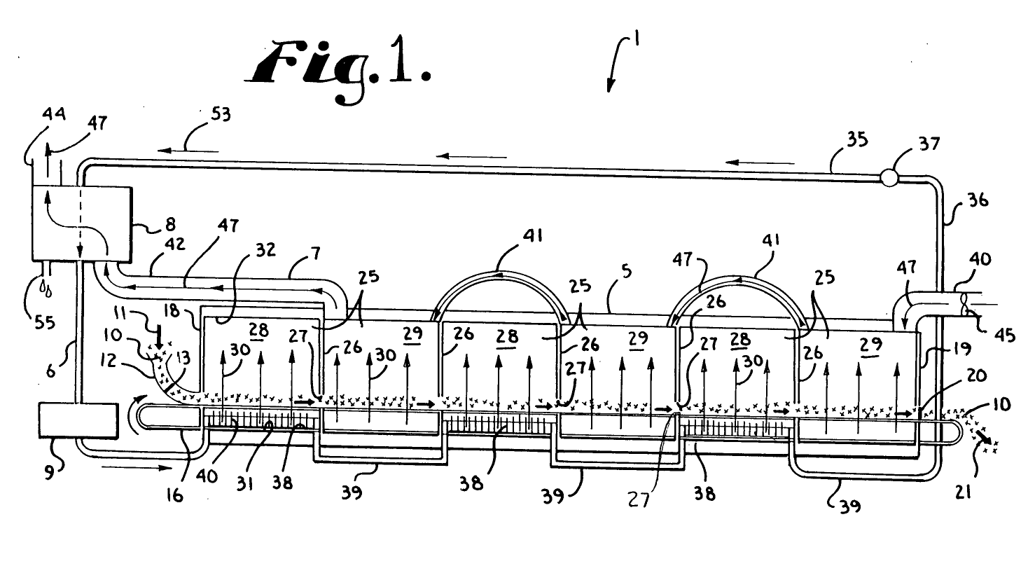

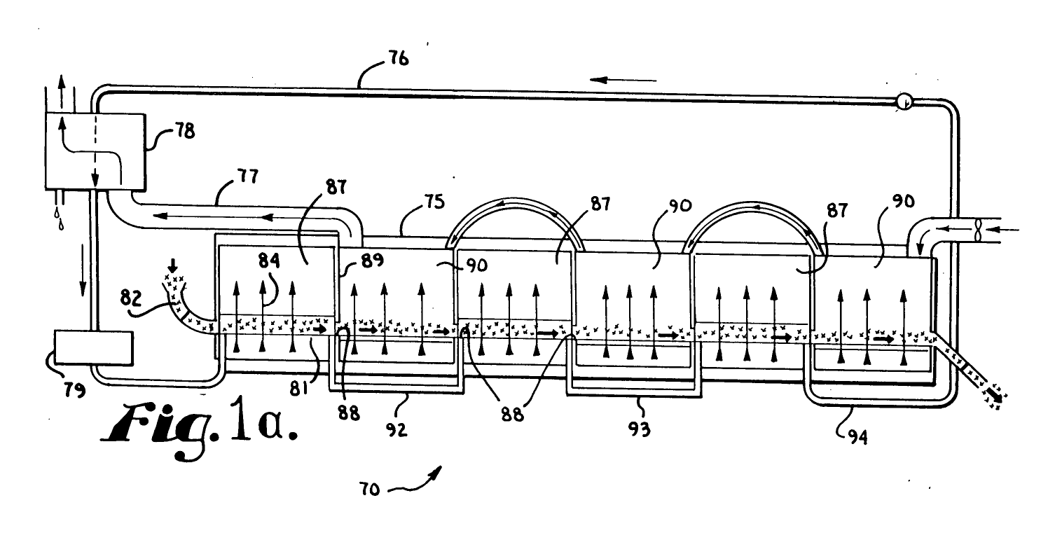

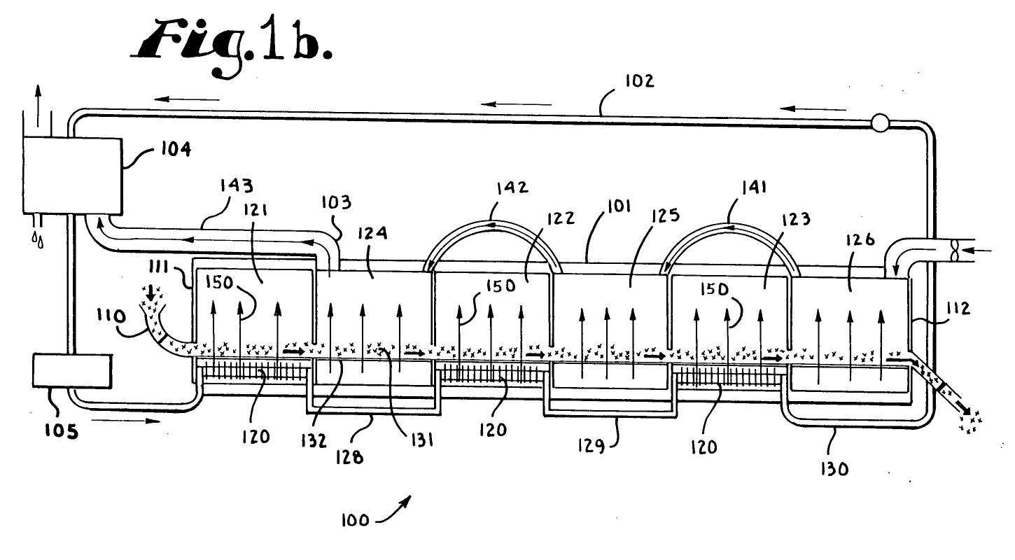

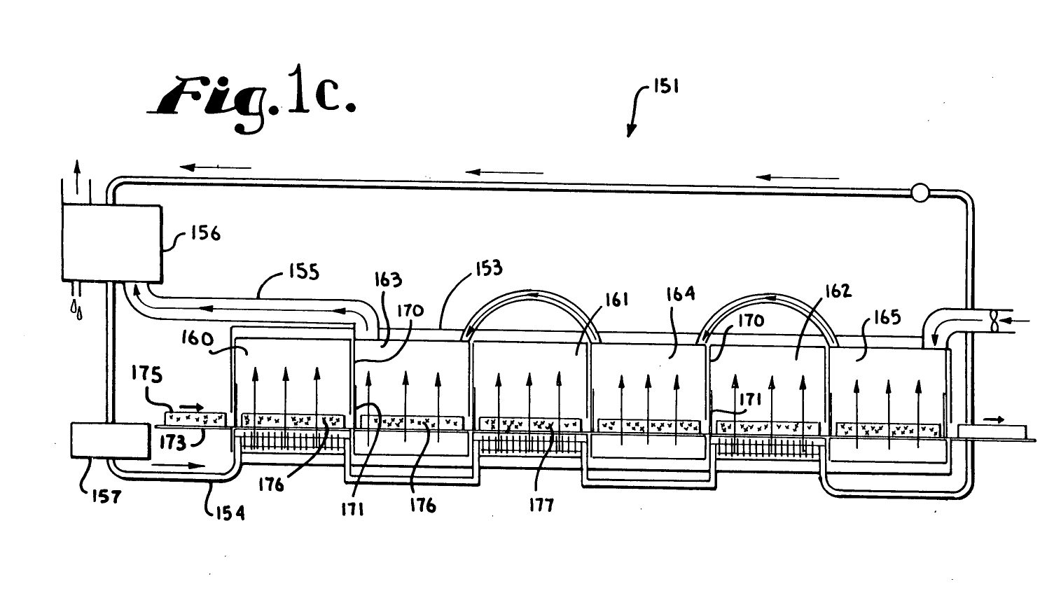

A particulate drier is shown in FIG. 1 generally indicated by the reference numeral 1. The drier 1 includes a drying chamber 5, a heating fluid recirculation system 6, a drying fluid recirculation system 7, a heating fluid regenerator 8 and a makeup heater 9. The drier 1 is for drying particulate material 10 generally represented by x's.

The particulate material 10 is fed as indicated by the reference numeral 11 into a feeder 12 having an air lock 13 that allows passage of the particulate material 10, but resists passage of air therethrough. The feeder 12 discharges the particulate material 10 onto a moving belt conveyor 16. The belt conveyor 16 extends longer than the length of the drying chamber 5 which is enclosed except whereat the belt 16 passes through a front wall 18 and rear wall 19 and junctures with the heating fluid recirculation system 6 and the drying recirculation system 7. At a rear wall 19 there is an air lock 20 allowing the belt conveyor 16 and material 10 to pass through, but restricts air flow therethrough. The particulate material 10 in a dried or in at least a partially dried state is discharged from the conveyor 16 to storage or the like as indicated by the reference numeral 21.

The drying chamber 5 is divided into a plurality of compartments 25. Each of the compartments 25 are generally separated or divided from adjacent compartments 25 by a wall structure 26. Each of the wall structures 26 have lower passageways 27 that allow the passage of the belt conveyor 16 and material 10 through, but substantially restrict air flow therethrough. The first, third and fifth (from the left) compartments 25 are heating compartments 28 and the second, fourth and sixth compartments 25 are drying compartments 29. There may be any number of drying and heating compartments or regions in conjunction with the invention.

A blower system, one for each chamber 25, that is indicated by the directional arrows 30 continuously recirculates a drying fluid, preferably air, continuously from a bottom 31 to a top 32 of each chamber 25 after which the fluid is returned to the bottom 31. During the upward flow of the fluid, the fluid passes through the conveyor belt 16, that is perforated for the purpose, and the material 10 being carried by the belt 16.

The heating fluid recirculation system 6 is designed to recirculate a fluid, preferably water, but other fluids may be utilized depending upon the requirements of the process and material being dried. In particular, the heating fluid system 6 includes a piping arrangement 35 having a return conduit 36, a pump 37, a series of heat exchangers 38 and connecting or bypass conduits 39. One of the heat exchangers 38 is located in each of the heating chambers 28 beneath the belt 16. Each heat exchanger 38 has fins 40 associated therewith that are positioned and spaced to allow the drying fluid circulating in each chamber 28 to pass through and past the exchangers 38 so as to become heated. The drying fluid in the heating chamber passes from the heat exchanger 38 through the material 10 to heat the material 10. Each heat exchanger 38 is connected sequentially with the next by the conduits 39. In this manner, the heating fluid is hottest at the first or front end 18 of the drying chamber 5 and cools as it passes through each subsequent heat exchanger 38, so as to be coolest at the second or rear end 19 of the chamber 5. Thus, the heating fluid passes in generally concurrent flow with respect to the material 10 to be dried and heat flow occurs from the heating fluid to the material by the temperature difference that results as the material temperature decreases in response to adiabatic phase change of moisture therein.

It is foreseen that the system 6 could be altered so that the flow of the heating fluid through each heating compartment 28 would not be partially or at all concurrent with the flow of the material 10 in that particular compartment 28, yet that the general overall flow of the heating fluid would be concurrent or generally concurrent with the flow of the material 10. For example, inlets and outlets of the heat exchanger 28 could be reversed so that within each heating compartment 28, the flow of the heating fluid would be countercurrent or cross current with respect to the material 10, but overall the heating fluid would generally flow from the front 18 to the rear 19 or concurrently with respect to the material 10.

The drying fluid circulation system 7 includes an inlet conduit 40, bypass conduits 41 and a discharge conduit 42. When the drying fluid is air which is preferably, the inlet conduit 40 simply flow connects the interior of the compartment 28 closest to the rear end 19 with outside or ambient air. Located in the inlet 40 is a drying fluid driver or fan 45. It is foreseen that the drying fluid driver could be located in other parts of the system 7, such as the conduit 42.

The bypass conduits 41 each flow connect spaced drying compartments 29 while bypassing the heating compartments 28. The drying fluid 41 both recirculates within and flows through the drying chambers 29, preferably with little or no flow through the lower passageways 27. The discharge conduit 42 flow connects the last of the drying compartments 29 that is closest to the front end 18 with a shell side of the regenerator 8. The regenerator 8 has an outlet 44 for the drying fluid from the conduit 42 that has passed through the regenerator 8. In this manner, drying fluid enters the drying circulation system 7 through the inlet 40 and passes through the drying compartments 29 while mixing with the fluid circulating therein mainly in cross flow relative to the material 10. The drying fluid, as represented by the arrows 47, flows generally counter flow to the material 10 in the chamber 5 so as to become heated and at least partially saturated with moisture and enter the regenerator 8 in a heated and moisture laden state. In the regenerator 8, the recirculating heating fluid (represented by arrows 53) enters the tube side of the regenerator 8 in a comparatively cool state. The heating fluid becomes heated by heat transfer from the drying fluid in the regenerator and leaves the regenerator 8 in a partially heated or preheated state. Preferably, the heating fluid flows counterflow to the drying fluid in the regenerator. Condensate from the moisture condensed from the drying fluid in the regenerator 8 collects and is discharged through a drain 55.

It is foreseen that the drying fluid exiting the regenerator 8 may contain excessive dust or may be a fluid that is too valuable to waste. In such circumstances, the drying fluid exiting the regenerator discharge 44 can be recycled to the inlet 40. When this occurs, it may also be necessary to add a chiller or heat pump to the recycle line to reduce the temperature of the drying fluid to the preselected temperature, thereby maintaining the drying potential of the drying chamber. Condensate collected in such a chiller is discharged to a drain or the like. It is foreseen that one or more heat pumps may be used to recover or extract heat from drying fluid exhausted from the regenerator, from the surrounding environment or otherwise and return such heat to be used in the drier or method, for example by preheating material, heating the heating fluid as or before another make up heater or the like.

After the heating fluid exits the regenerator 8, the temperature of the heating fluid would normally not be at a preferred temperature to dry the material due to small heat losses in the process. The make up heater 9 is therefore utilized to raise the temperature of the heating fluid to a preselected range or preferred temperature such as 180° F., that varies with the material to be dried.

In use material 10 to be dried enters the front of the chamber 5 in generally overall concurrent flow with the heating fluid while the drying fluid enters the rear of the chamber 5 in generally overall countercurrent flow to the material 10. The material 10 at the chamber front 18 is in a wet state and at the chamber rear 19 is in a dry or drier state. The drying fluid removes heat and moisture from the material in the drying compartments 29. The heating fluid transfers heat to the material 10 in the heating compartments 28 which is circulated therein by drying fluid. The drying fluid in a comparatively cool state enters the chamber 5 near the rear end 19 and exits near the front end 18 in a wet warm state thereby drying the material 10. The heating fluid enters the chamber 5 near the front end 18 in a comparatively warm state and exits near the rear end 19 in a cool state. The heating fluid enters the regenerator 8 in a cool state and exits in a partially warm state, and thereafter passes through the makeup heater 9 and is then in the warm state thereof. It is noted that the drying fluid serves two major functions. The first function is to pass countercurrently through the material 10 in the drying compartments 29 so as to dry and cool the material. The second function is to circulate in cross flow through the material 10 in the heating compartments 28 and transfer heat from the heating fluid to the material 10 therein.

FIG. 1A illustrates a drier generally identified by the reference numeral 70 which is a variation of drier 1. Structures of the drier 70 that function in a manner like drier 1 are not described in detail and reference is made to the description for drier 1 for additional detail.

The drier 70 includes a drying chamber 75, a heating fluid recirculation system 76, a drying fluid circulation system 77, a regenerator 78 and a makeup heater 79. The drier 70 differs from the drier 1 principally in that the conveyor belt of drier 1 is replaced by a perforated plate 81 so as to produce a fluidized bed with respect to material 82 to be dried when air recirculates through the bed 81 indicated by the arrows 84. The heating fluid in this embodiment passes into and through heating compartments 87 in close proximity and in a heat exchange relationship to the bed 81, so as to transfer heat from the heating fluid to the material 82. Partial or nearly full air locks 88 at each wall 89 separate heating compartments 87 from drying compartments 90 and resist the mixing of fluids recirculating in the heating compartments 87 and drying compartments 90.

In drier 70 the heating fluid travels generally overall concurrently with respect to the flow of the material 82 in that the recirculation system 76 enters the chamber 75 near whereat the material 82 enters the chamber 75, flows through each heating compartment 87 sequentially and bypasses each drying compartment 90 through bypass conduits 92, 93 and 94 and thereafter exits the chamber 75 near whereat the material 82 exits the chamber 75. It is foreseen that in some embodiments the heating fluid can flow in countercurrent, concurrent, cross and mixed flows relative to the material 82 on a micro or limited basis, especially in specific sectors or regions while general overall flow of the heating fluid relative to the material 82 is concurrent in the chamber 75.

Drying fluid flows through the circulation system 77 through the drying compartments 90 overall generally counter current to the material 10 while in the chamber 75 and exchanges heat with the heating fluid in the regenerator 78.

FIG. 1B shows a drier generally identified by the reference numeral 100 which is a variation of drier 1. Structure in drier 100 that is the same or functions the same as structure in drier 1 is not described in detail and reference is made to the description of drier 1 for additional detail.

The drier 100 includes a drying chamber 101, a heating fluid recirculation system 102, a drying fluid circulation system 103, a regenerator 104 and a makeup heater 105. Material 110 to be dried enters a front end 111 of the chamber 101 and exits a rear end 112.

Heating fluid flows in the heating fluid recirculation system 102 and sequentially enters finned heat exchangers 120 sequentially in heating compartments 121, 122 and 123. Heating fluid bypasses drying compartments 124, 125 and 126 through bypasses 128 and 129 and exits through conduit 130. Heat is transferred from each heat exchanger 120 to fluid (normally drying fluid that generally remains in and circulates in the heating compartments 121) recirculating from bottom to top through each heating compartment 121, 122 and 123 as noted by arrows 150. The material 110 flows through the chamber 101 as a fluidized bed 131 on a perforated plate 132 that allows recirculating air to transfer heat to the material 110 in the bed 131.

Drying fluid, preferably air, is drawn into the chamber 101 near the rear end 112 and flows sequentially through the drying chambers 126, 125 and 124 generally overall countercurrent to flow of the material 110. However, in each drying compartment the drying fluid flows in a cross and mixed flow manner as the drying fluid is mixed with the circulating air so as to partially flow cross flow through the material 110 while also partially flowing countercurrently across the top of the material 110. Drying fluid bypasses heating compartments 123, 122 and 121 by flowing through bypasses 141 and 142, as well as discharge conduit 143.

The drying fluid flows from the discharge conduit 143 into the regenerator 104 whereat it preheats the heating fluid being returned from the chamber rear end 112 by the heating fluid recirculation system 102.

FIG. 1C is directed to a drier 151 that is another variation of drier 1. Structure in drier 151 that is the same or generally the same as that of drier 1 is not described in detail and reference is made to the description of drier 1 for additional description.

The drier 151 includes a drying chamber 153, a heating fluid recirculation system 154, a drying fluid circulation system 155, a regenerator 156 and a makeup heater 157.

The drying chamber 153 includes three heating chambers 160, 161 and 162 and three drying chambers 163, 164 and 165. Adjacent compartments 160 to 165 are separated from one another by walls 170 each with a flap or air lock 171 to resist circulation of air between heating chambers 160, 161 and 162 and drying chambers 163, 164 and 165.

The drying chamber 153 includes a conveyor 173 that conveys material 175 through the chamber 153. The conveyor 173 shown is a chain link construction or type, but it is foreseen that rollers, or the like can function within the scope of the invention. The material 175 in this embodiment is in the form of discrete units 176 such as loose particulate material contained in perforated trays 177 that allow passage of air flow therethrough. Alternatively, it is foreseen that the material to be dried may be in porous blocks that allow flow of air through the blocks. Still further the material may be multiple discrete blocks of generally non porous material or the like.

It is foreseen that the drying chamber of the invention could also be a rotary drum or tunnel wherein the heating fluid is conveyed to adjacent heating regions by tubing wrapped helically about the drum and drying fluid is conveyed to subsequent drying regions through an inner tube.

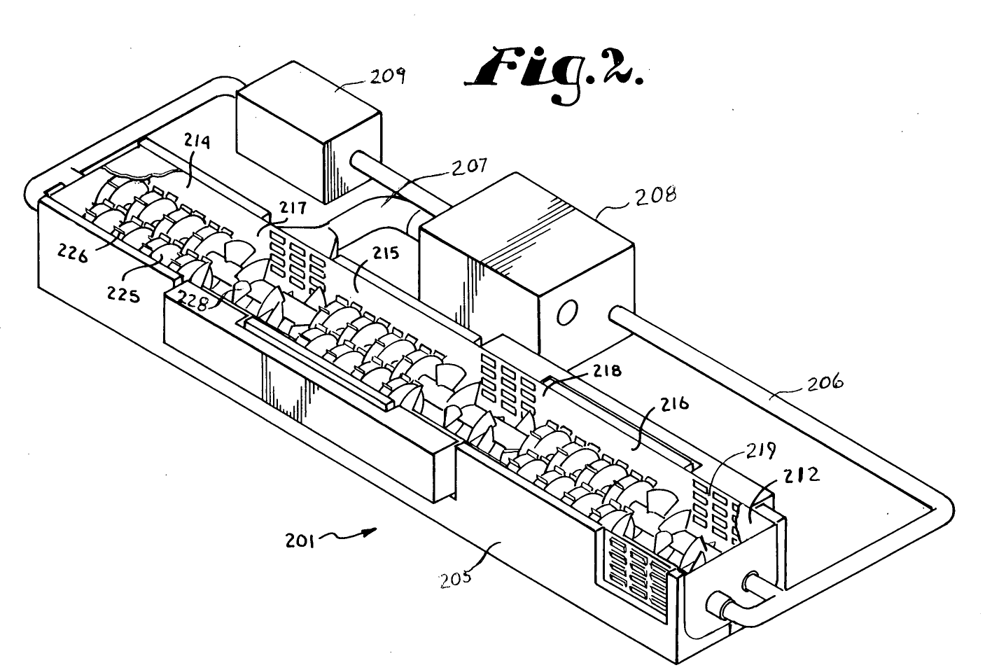

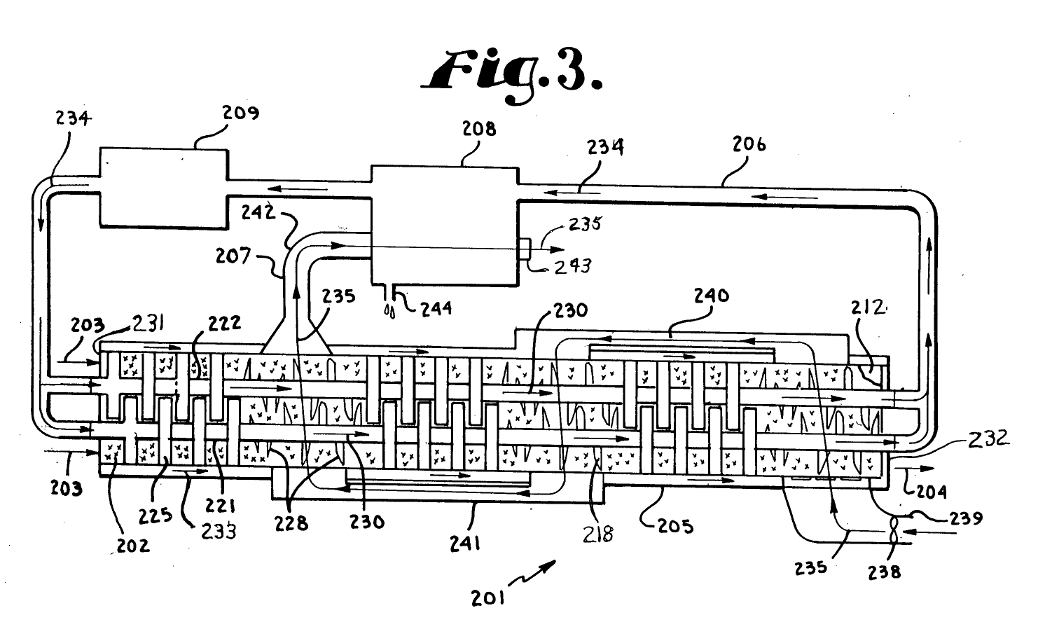

FIGS. 2 and 3 illustrate an alternative drier of the invention generally indicated by the reference numeral 201. While the method of transporting material 202 to be dried through the drier 201 is different in comparison to drier 1, many aspects of the drier 201 are similar to and/or function in the same manner as drier 1, so reference is made to the description of drier 1 for additional detail.

Material 202 enters the drier 201 as indicated by the reference arrows 203 and exits the drier as indicated by the reference numerals 204. The drier 201 includes a drying chamber 205, a heating fluid recirculation system 206, a drying circulation system 207, a regenerator 208 and a makeup heater 209.

The drying chamber 205 is an elongate enclosed box shown in FIGS. 2 and 3 with a top 212 mostly removed to show the interior thereof. The chamber 205 is divided into three heating regions or compartments 214, 215 and 216 and three drying regions or compartments 217, 218 and 219. There may be any number of drying and heating compartments consistent with the invention. It is foreseen that in some embodiments partial walls between adjacent regions may be required to resist unwanted flow of drying fluid between adjacent regions.

Passing through the chamber 205 lengthwise are a pair of rotating tubes 221 and 222. It is foreseen that a single tube or additional tubes may be utilized in accordance with the invention. Mounted on each of the tubes 221 and 222 in each of the heating chambers 214, 215 and 216 are a plurality of hollow discs 225 and optimally with external flow directing fins 226, as is illustrated. Located on each of the tubes 221 and 222 in each of the drying chambers 217, 218 and 219 are a plurality of mixing and driving paddles 228. The interior of each tube 221 and 222 is flow connected to and part of the heating fluid recirculation system 206 and flow of heating fluid therein is indicated by arrows 230. Preferably, the level of material 202 in each of the compartments 214 to 219 is sufficient to resist air flow beneath the top 212, but to allow the material 202 to be conveyed from a chamber front end 231 (arrows 203) to a rear end 232 (arrows 204). The fins 226 and paddles 228 both mix the material 202 and drive the material 202 through the drier 201. Preferably, the tubes 221 and 222 are insulated in the drying compartments 217, 218 and 219. Flow of the material 202 is generally overall sequentially from through compartments 214, 217, 215, 218, 216 and lastly through 219.

The heating fluid flows in the heating recirculation system 206, and when in the chamber 205, generally overall concurrently with the material 202. In particular, when in the chamber 205, the heating fluid flows through the rotating tubes 221 and 222 so as to heat the discs 225 which in turn rotate through the material 202 and drive the material through each heating compartment 214, 215 and 216. It is foreseen that the heating fluid may also flow through an outer jacket or shell of the drying chamber as is indicated by reference arrows 233. The heating fluid enters the compartment 205 in a comparatively heated state, preferably to a preselected temperature for the material 202 being dried, for example 180° F., and exits the chamber 205 in a comparatively cool state, for example 80° F. Flow of the heating fluid through the chamber 205 is indicated by the reference arrows 230 and through the remainder of the system 206 by reference arrows 234. The heating fluid exits the chamber 205 and flows to the regenerator 208 which in this embodiment is a shell and tube heat exchanger. The heating fluid flows through the inside of tubes of the regenerator 208. Subsequently, the heating fluid flows to the makeup heater 209 wherein heat is transferred to the heating fluid to raise the temperature thereof to the preselected temperature desired for the heating fluid entering the chamber 205.

The drying fluid, generally indicated by the arrows 235 is preferably ambient air, but it is foreseen that the drying fluid can be recycled air or another fluid. The drying fluid is drawn and then driven by a fan 238 at an inlet 239 into the chamber 205. The drying fluid passes sequentially through drying compartments 219, 218 and 217 while bypassing heating compartments 216 and 215 through bypass conduits 240 and 241. The drying fluid exits the chamber 205 through a discharge conduit 242 and enters the shell side of the regenerator 208. The drying fluid passes through the regenerator 208 in heat transfer relationship with the heating fluid therein so as to preheat the heating fluid. The drying fluid exits the regenerator 208 through outlet 243 and is discharged into the air. Condensate that collects on the shell side of the regenerator 208 is collected and discharged through drain 244.

The drying fluid enters the chamber 205 near the rear end 232 in a comparatively cool state, for example at 70° F., and passes sequentially through the interiors of the drying chambers 219, 218 and 217 while becoming heated by the material 202 and absorbing moisture so as to become at least partially saturated by moisture from the material 202 at the heated temperature thereof. The drying fluid exits the chamber 205 in a comparatively warm wet state, for example 170° F., and partially or fully saturated. The drying fluid exits the regenerator cooler and dryer, for example 80° F. and saturated, in comparison to entry into the regenerator 208. When referring to the material 202 and heating fluid being dryer, the term dryer means that the total moisture content is less and not that relative saturation at a particular temperature is less.

While the heating and drying regions of drier 201 are shown in a linear alignment, it is foreseen that a rotating disc drier of this type could also be constructed wherein pairs of heating and drying regions are stacked on top of one another or other configuration.

It is foreseen that the axis of the rotating discs may be mounted perpendicular to the axis shown in the present embodiment. It is also foreseen that hollow screws or the like could be utilized instead of the illustrated hollow discs.

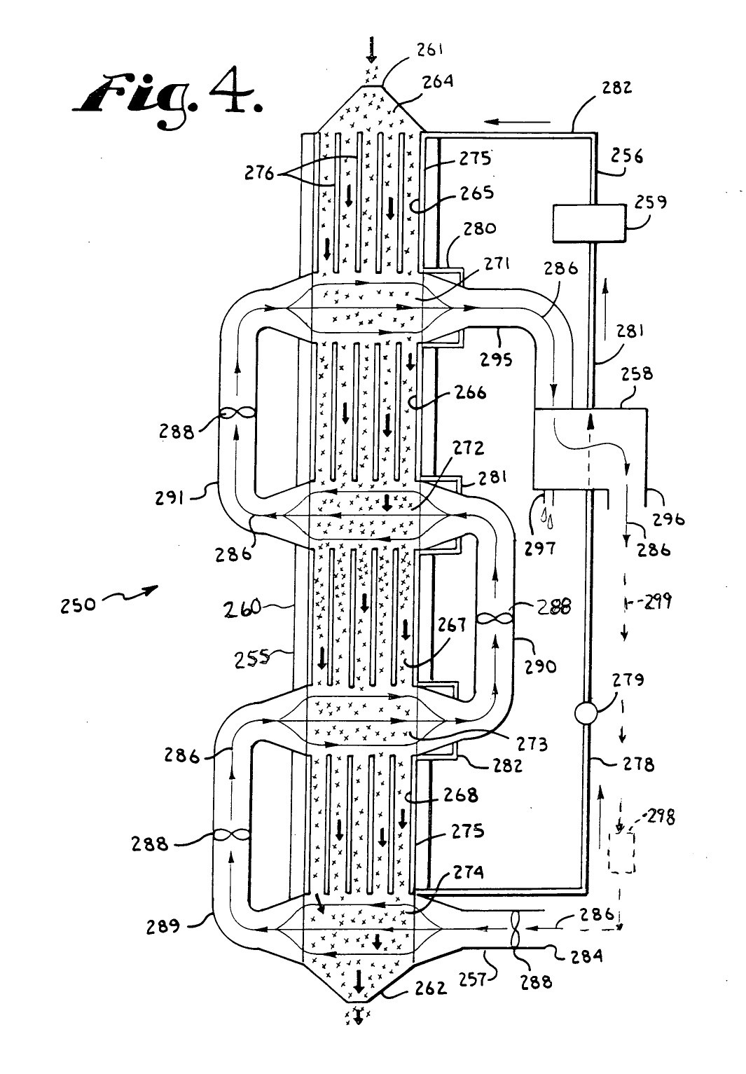

Shown in FIG. 4 is a drier in accordance with the present invention that is generally indicated by the reference numeral 250. Portions of the structure of drier 250 are similar to the structure of drier 1 and reference is made to the description of drier 1 for additional detail.

The drier 250 includes a drying chamber 255, a heating fluid recirculation system 256, a drying fluid circulation system 257, a regenerator 258 and a makeup heater 259.

The drying chamber 255 includes a vertical column 260 having an upper inlet end 261 and a lower outlet end 262. Material 264 to be dried and generally indicated by x's throughout the chamber 255 flows into the inlet end 261 and through the chamber 255 due to gravity and out the outlet end 262.

The chamber 255 includes four heating regions 265, 266, 267 and 268 and four drying regions 271, 272, 273 and 274 through which the material 264 flows. As noted previously, it is foreseen that there may be various numbers of total sets of heating and drying regions used in the process. It is foreseen that vibratory mechanisms may be attached to the vertical column to aid the flow of material therethrough.

The heating fluid recirculation system 256 includes interconnected vertical hollow plates or conduits 275 located within each heating region 265, 266, 267 and 268 and positioned so as to be in surface contact with the material 264 therein. In the illustration the conduits 275 include multiple spaced vertical units 276 that are flow interconnected in each of the regions 265, 266, 267 and 268. A discharge conduit 278 with a pump 279 joins the conduit 275 of the final heating region 268 with a tube side of the regenerator 258. Further conduits 281 and 282 flow connect the regenerator 258 with the makeup heater 259 and the makeup heater 259 with the conduit 275 of the first heating region 265 respectfully.

The drying fluid circulation system 257 includes an inlet 284 for drawing drying fluid identified by the reference arrow 286 throughout the drier 250 into the chamber 255 by operation of blowers or fans 288 and, in particular, first into the drying region 274. The circulation system 257 includes bypasses 289, 290 and 291 flow connecting drying regions 274 with 273, 273 with 272 and 272 with 271 respectively. Drying fluid is discharged from the chamber 255 through outlet conduit 295 which flow connects with the shell side of the regenerator 258. The drying fluid exits the regenerator 258 through an outlet 296. The shell side of the regenerator 258 also collects condensate that is discharged through a drain 297. The inlet 257, each bypass 289, 290 and 291, and the outlet 295 conduits are each joined with the chamber 255 on opposite sides of associated drying regions 271, 272, 273 and 274 respectfully so as to produce a general cross flow of the drying fluid through the material 264. The chamber 255 has perforated sides in the region of such connections to prevent the material from flowing from the chamber 255, but to allow flow of drying fluid therethrough.

In this manner, the material 264 flows generally overall concurrent with the heating fluid through the chamber 255, although it is foreseen that the actual segment of flow in each heating region 265 to 268 may be concurrent, cross flow, countercurrent or mixed flow. The flow of drying fluid overall is generally countercurrent to the flow of material 264, but is generally cross flow within each separate drying region 274 to 271. The drying fluid exiting the chamber 255 is utilized to preheat the heating fluid in the regenerator 258 and makeup heat is added to the heating fluid in the makeup heater 259.

It is foreseen in some instances that drying fluid from the regenerator 258 may be recycled through a chiller 298 by a conduit represented by phantom line 299 to maintain a generally uniform temperature of drying fluid entering the chamber 255 while reusing the drying fluid. It is foreseen that a heat pump may be used instead of a chiller.

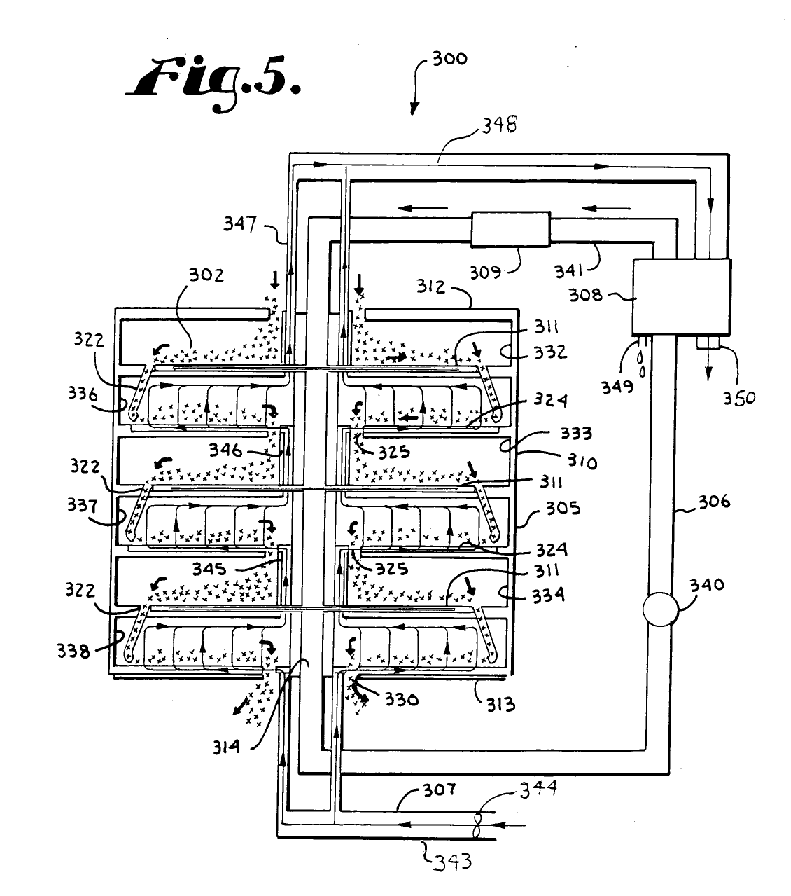

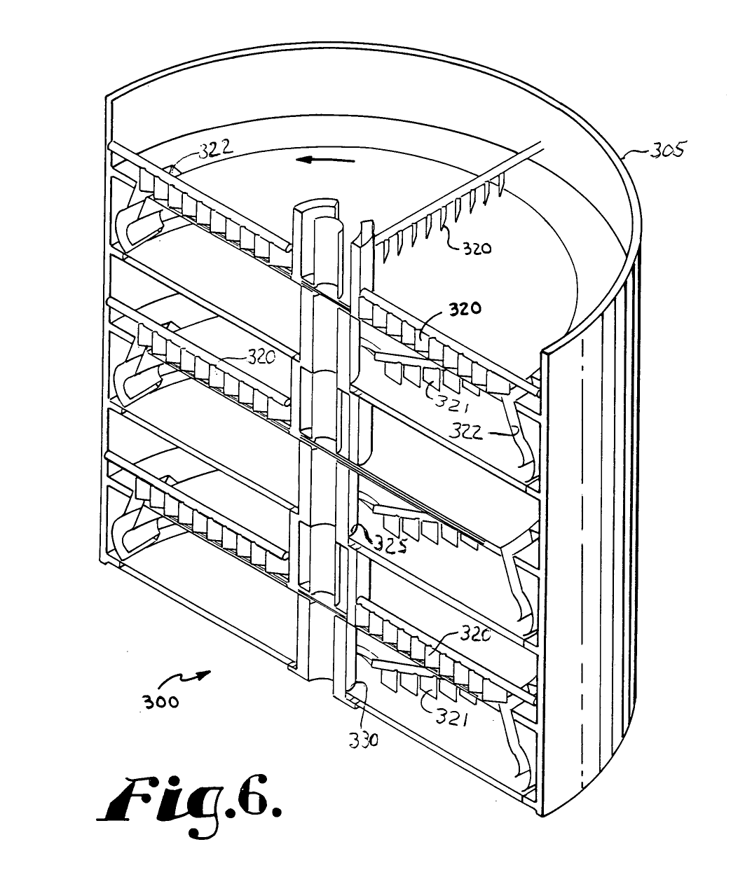

Illustrated in FIGS. 5 and 6 is a drier in accordance with the present invention which is generally indicated by the reference numeral 300. The drier 300 is a rotating plate type drier for drying material 302 generally indicated by x's throughout FIG. 5. The drier 300 includes a drying chamber 305, a heating fluid recirculation system 306, a drying fluid circulation system 307, a regenerator 308 and a makeup heater 309. The drying chamber 305 is shown with material 302 therein in FIG. 5 and without material 302 in cross section in FIG. 6 to allow better illustration of the structure thereof.

The chamber 305 is generally a cylindrical shaped drum 310 with a series of vertically spaced circular plates 311 that are generally equally spaced and rotatably mounted within the drum 310. The drum 310 also has a top 312 and bottom 313. The plates 311 are each centrally joined to a vertical feeder conduit 314. The interior of the plates 311 are so configured to generally direct the flow of heating fluid radially outward to the outer radius of the plate, and then radially inward toward the center so as to flow connect with vertical feeder conduit 314. The conduit 314 allows heating fluid to flow sequentially and downward through each of the plates 311 so as to heat the plates 311 and material 302 thereon. A series of mixing and diverter paddles 320 engage the material 302 as the material 302 rotates on the plates 311 and both mixes the material 302 and urges the material 302 to the outside to downcomer chutes 322. The chutes 322 also function as air locks to resist drying fluid from entering heating regions. Positioned between plates 311 are walls 324 that are also associated with structure 321 that drives the material 302 radially inward to a set of openings 325 that allow passage of the material 302 to the next lower plate 311 or in the case at the bottom end to a discharge 330.

In this manner heating regions 332, 333 and 334 are formed in association with the plates 311 wherein heating fluid flows generally radially outward and overall generally concurrently with the material 302 in the plates 311. Further drying regions 336, 337 and 338 are formed sequentially after respective heating regions 332, 333 and 334.

The conduit 314 feeds the plates 311 with heating fluid and joins with a heating fluid pump 340 and a tube side of the regenerator 308. A transfer conduit 341 flow connects the regenerator 308 with the makeup heater 309 which is in turn flow connected to the conduit 314.

The drying fluid circulation system includes a drying fluid inlet 343 through which fluid (here air) is drawn by a fan 344 which it is foreseen can be located in many parts of the circulation system 307. The inlet 343 is joined to the drying region 338 and connected so as to direct the drying fluid radially outward across the bottom of the region 338 and to discharge it upward through perforations into region 338. A bypass 345 joins the region 338 with the region 337 wherein drying fluid is again discharged and then transferred by a bypass 346 to the drying region 336 and finally to an outlet 347. The outlet 347 flow connects with a shell side of the regenerator 308.

In this manner, the drying fluid, as indicated by arrows 348, flows in a generally cross flow manner relative to the flow of material 302 through each of the individual drying regions 338, 337 and 336 while flowing in a generally overall countercurrent manner relative to the flow of material 302 throughout the entire chamber 305.

The drying fluid exiting the chamber 305 in a warm state is utilized to preheat the heating fluid in the regenerator 308 and subsequently discharged through an outlet 350. Condensate is collected in the regenerator 308 and discharged through a drain 349.

It is foreseen that a rotary drum can be utilized in the invention with multiple pairs of heating and drying regions wherein material to be dried flows alternatively through heating regions and paired drying regions. Heating fluid flows generally concurrently with the material through the drum and sequentially through each heating region. Drying fluid flows in generally countercurrent flow to the material and sequentially through each of the drying regions. The drying fluid exiting the drum is used to preheat the heating fluid exiting the drum.

It is foreseen that the regenerator used in any embodiment may be other than a shell and tube heat exchanger, and may be any type of exchangers that is capable of transferring heat from the drying fluid to the heating fluid function within the scope of the invention.

While a continuous counter flow process is described for the chamber and the regeneration systems in the embodiments described, it is foreseen that batch processes could be utilized using one or a series of sequential batch operations.

It is foreseen that the material to be dried may be conveyed through the chamber by other types of systems including, but not limited to augers, belts and the like. It is foreseen that the overall drying chamber can be of a wide variety of chamber types allowing for the required flows.

While air and nitrogen are the most likely fluids to be used in a process of this type, it is foreseen that other fluids such as argon or the like may be used. Furthermore, while particular materials to be dried have been generally mentioned herein, it is foreseen that a wide variety of materials may be dried, including particulates and other granular materials, powders, flakes, pastes, slurries, and solids in general. Such materials are not restricted to but may be represented by foodstuffs, such as grains, including corn, beans, dog food, mixes, meals and flours; chemicals such as clays, coals, sand; and processed materials, such as paper and the like.

It is foreseen that the drying chamber and the regenerator can be operated under vacuum or pressurized in certain embodiments. It is also foreseen that, the examples provided herein remove moisture from a material to be dried, other volatile fluids including solvents and the like can be removed from materials to be dried in accordance with the driers and methods of the present invention.

As used herein the phrase “substantially overall concurrently” with respect to flow of the heating fluid relative to the material to be dried, means that both enter the chamber near one end and exit the chamber near the opposite end but during travel through the chamber, segments or portions of the drying fluid may flow in cross flow, counter flow or mixed flow relative to the material.

It is to be understood that while certain forms of the present invention have been illustrated and described herein, it is not to be limited to the specific forms or arrangement of parts described and shown.

What is claimed and desired to be secured by Letters Patent is as follows:

1. A drier apparatus for drying a material utilizing a heating fluid and a drying fluid comprising:
a) a drying chamber having first and second ends; said chamber being divided into at least one heating region followed by at least one drying region; said chamber being sized and shaped to operably receive said material near said first end and the drying fluid in a cool state near said second end;
b) a heating fluid recirculation system for operatively flowing said heating fluid through said heating region to transfer heat to said material while said material is within said drying chamber and such that said heating fluid flows substantially overall concurrently with said material through said chamber, so that said material becomes heated by said heating fluid and releases moisture;
c) a drying fluid circulation system for operably flowing said drying fluid through said drying region so as to become heated and at least partially saturated with said moisture from said material;
d) a heating fluid regenerator operably receiving drying fluid in a heated state exiting from said chamber and heating fluid in a cool state exiting from said chamber in heat exchange relationship so as to preheat said heating fluid; and
e) a make up heater operably supplying makeup heat to said drier.

2. The drier apparatus according to claim 1 including:
a) a plurality of heating regions; and
b) a plurality of drying regions wherein each heating region is separated from a sequential heating region by a paired drying region.

3. The drier apparatus according to claim 1 including:
a) a fluid conduit flow joining a drying fluid discharge end of said regenerator system with said chamber, so as to provide for recycling of the drying fluid; and
b) a heat removing device located in said fluid conduit adapted to cool the drying fluid passing through said fluid conduit to a preselected temperature.

4. The drier according to claim 3 wherein:
a) the heat removal device is a chiller.

5. The drier according to claim 3 wherein:
a) the heat removal device is a heat pump that is configured to return heat to be utilized by the drier.

6. The drier according to claim 1 wherein:
a) said makeup heater is located in said heating fluid recirculation system between said regenerator and said chamber.

7. The drier according to claim 1 wherein:
a) said chamber is a fluidized bed.

8. The drier according to claim 1 wherein:
a) said chamber is a rotating disc chamber.

9. The drier according to claim 1 wherein:
a) said chamber is a rotating plate chamber.

10. The drier according to claim 1 wherein:
a) said chamber is a vertical column.

11. The drier according to claim 1 wherein:
a) said chamber is a tunnel chamber.

12. The drier according to claim 1 wherein:
a) said chamber is a conveyor chamber selected from the group consisting of belt, chain and link conveyors.

13. The drier according to claim 1 wherein:
a) said chamber is selected from a group consisting of rotary drum, inclined column, conveyorized tunnel, rotary screw, rotary plough, paddle, tray, web and band chambers.

14. The drier according to claim 1 wherein:
a) said heating and drying regions are at least partially separated by wall structure.

15. The drier according to claim 1 wherein:
a) said heating fluid recirculation system is configured in each heating region so that said heating fluid flow is selected from a group including concurrent, countercurrent, cross and mixed flows in each separate heating region while overall flow of heating fluid relative to said material is concurrent through the chamber.

16. The drier according to claim 1 wherein:
a) said drying fluid recirculation system is configured in each drying region so that said drying fluid flow is selected from a group including concurrent, countercurrent, cross and mixed flows in each separate drying region while overall flow of drying fluid relative to said material is countercurrent through the chamber.

17. A method of drying a material comprising the steps of:
a) providing a drying chamber with at least one heating region and at least one paired drying region;
b) passing the material through the drying chamber from a first end to a second end thereof;
c) flowing a heating fluid initially in a heated state relative to said material in generally overall concurrent flow through the heating region and in heat transfer contact with said material while substantially bypassing said drying region;
d) flowing a drying fluid through the material in the drying region substantially bypassing said heating region, such that the drying fluid receives heat and moisture from the material and the drying fluid exits the chamber in a warm and wet state in comparison to entry of the drying fluid into the chamber and so that the material exits the chamber drier in comparison to entry of the material into the chamber;
e) withdrawing the heating fluid from the chamber and the drying fluid from the chamber and thereafter utilizing the drying fluid to preheat the heating fluid;
f) thereafter returning the heating fluid in a heated state to the chamber to heat the material to be dried; and
g) adding make up heat to the drier for heat lost in the method.

18. The method according to claim 17 including:
a) providing a plurality of heating regions and paired drying regions; and
b) passing the material through all of the regions, the drying fluid through all of the drying regions and the heating fluid through all of the heating regions.

19. The method according to claim 17 including:
a) flowing said drying fluid in a flow selected from the group consisting of concurrent,
countercurrent, cross and mixed flows through each individual drying region while flowing the drying fluid generally overall countercurrent through said chamber relative to said material.

20. The method according to claim 17 including:
a) flowing said heating fluid in a flow selected from the group consisting of concurrent,
countercurrent, cross and mixed flows through each individual heating region while flowing the heating fluid generally overall concurrent through said chamber relative to said material.

21. The method according to claim 17 wherein:
a) withdrawing said heating fluid from near said chamber second end and withdrawing said drying fluid from near said chamber first end.

22. The method according to claim 17 including:
a) adding the makeup heat to the heating fluid between the regenerator and the chamber.

23. The method according to claim 17 including the step of:
a) collecting the drying fluid subsequent to utilizing the drying fluid to preheat the heating fluid and returning the collected drying fluid to second end of the chamber.

24. The method according to claim 23 including the step of:
a) chilling the drying fluid to a lower temperature prior to returning the drying fluid to the second end of the chamber.

25. The method according to claim 17 including the step of:
a) counter flowing said drying fluid relative to the material through each drying region in the chamber for the entire length of the chamber.

26. The method according to claim 17 including the step of:
a) cross flowing said drying fluid relative to the material in the chamber through each drying region.

27. The method according to claim 17 including the step of
a) flowing the drying fluid at least partially in counter flow through the material while the material is in the chamber.

28. The method according to claim 17 including the step of:
a) cross flowing the drying fluid through each of the drying regions of said chamber while overall generally counter flowing the drying fluid relative to said material while said material is within the chamber.

29. The method according to claim 17 including the step of:
a) mixed flowing the drying fluid through each of said drying regions of said chamber while overall generally counter flowing the drying fluid relative to said material while said material is within the chamber.

30. The method according to claim 17 including the step of:
a) concurrent flowing the drying fluid through each of said drying regions of said chamber while overall generally counter flowing the drying fluid relative to said material while said material is within the chamber.

31. The method according to claim 17 including the step of:
a) concurrently flowing said heating fluid relative to said material through each heating region in the chamber for the entire length of the chamber.

32. The method according to claim 17 including the step of:
a) flowing the heating fluid in a flow selected from cross flow, concurrent flow, counter current flow and mixed flows through each individual heating region relative to the material flow in the chamber while generally overall flowing the heating fluid concurrently relative to the material in the chamber.

33. In a drying process wherein a material is to be at least partially dried, the improvement comprising the steps of:
a) providing a drying chamber with a plurality of alternating and paired heating regions and drying regions;
b) flowing the material from a first end of the chamber to a second end thereof;
c) flowing a heated fluid generally overall concurrently relative to the flow of said material while said material is in said chamber sequentially through each of said heating regions while substantially bypassing each of said drying regions and while transferring heat to said material in said chamber;
d) flowing a drying fluid in direct contact with said material sequentially through each of said drying regions while substantially bypassing said heating regions and generally overall countercurrent to the flow of said material while in said chamber, such that the drying fluid becomes heated and takes up moisture from said material and such that said material exits the second end of said chamber drier in comparison to the material at said first end of said chamber and said drying fluid becomes warmer and at least partially saturated during passage through said chamber;
d) utilizing said drying fluid subsequent to passage through the chamber to preheat the heating fluid; and
e) adding make up heat lost in the process.

34. The method according to claim 33 including the step of:
a) countercurrent flowing the drying fluid through the heating fluid in the regenerator.

35. The method according to claim 33 wherein:
a) said drying chamber is a composite chamber including different combined portions of a plurality of types of chambers.

36. A drier apparatus for drying a material utilizing a heating fluid and a drying fluid comprising:
a) a drying chamber having first and second ends; said chamber being divided into at least one heating region followed by at least one drying region; said chamber being sized and shaped to operably receive said material near said first end and the drying fluid in a cool state near said second end;
b) a heating fluid recirculation system for operatively flowing said heating fluid through said heating region to transfer heat to said material while said material is within said drying chamber, so that said material becomes heated by said heating fluid and releases moisture;
c) a drying fluid circulation system for operably flowing said drying fluid through said drying region so as to become heated and at least partially saturated with said moisture from said material;
d) a heating fluid regenerator operably receiving drying fluid in a heated state exiting from said chamber and heating fluid in a cool state exiting from said chamber in heat exchange relationship so as to preheat said heating fluid; and
e) a make up heater operably supplying makeup heat to said drier.

37. The method according to claim 36 wherein:
a) the heating fluid flows generally overall countercurrently with respect to the material in the drying chamber.
